(19) United States
(12) Patent Application Publication
(10) Pub. No.: US 2010/0300840 A1
(43) Pub. Date: Dec. 2, 2010

(54) Gravity Conveyor System

(75) Inventor: Michael J. O'Brien, Richmond, MI (US)

Correspondence Address: HARNESS, DICKEY & PIERCE, P.L.C., P.O. BOX 828, BLOOMFIELD HILLS, MI, 48303, US

(73) Assignee: Bleichert, Inc., Sterling Hights, MI (US)

(21) Appl. No.: 12/472,850

(22) Filed: May 27, 2009

(51) Int. Cl. B65G 47/56; B65G 13/11

(52) U.S. Cl. 198/560; 198/860.1

(57) ABSTRACT

A gravity conveyor assembly includes first and second track assemblies positioned parallel to each other. Each of the track assemblies includes a body, having a slot in a first surface. A track member includes a frictional engagement portion received and frictionally engaged within the slot. A track extending portion freely extends above the first surface of the body. The track extending portion is oriented at an angle with respect to an axis oriented transverse to a ground surface such that the track extending portion has a continuous slope with respect to the ground surface. A cassette supported on the first and second track members is adapted for gravity induced rolling motion by the continuous slope. Wheels mounted to opposed sides of the cassette each have a concave perimeter surface aligned for rolling contact with the track extending portion of the track assemblies.

### FIELD

The present disclosure relates to conveyor systems having inclined support rails that allow gravity induced motion of conveyed product carriers.

### BACKGROUND

This section provides background information related to the present disclosure which is not necessarily prior art.

Known gravity conveyor systems such as those disclosed in U.S. Pat. Nos. 4,359,945 to Brems et al. and 4,215,772 to Graham provide rail tracks that are made of thin metal material having intermittently provided support members. The spacing of the support members can allow distortion in the unsupported portions of the track and therefore allow for discontinuous slope of the track, resulting in either undesirable increased or decreased speed of transfer.

Conveyor systems such as the Brems et al. and Graham systems also do not provide for retention of the pallet except as directly supported by the rails. Moving pallets that contact each other or that contact non-moving pallets on the rail, for example at stop, loading, or un-loading points can cause one or more of the pallets to jump off the rail.

### SUMMARY

This section provides a general summary of the disclosure, and is not a comprehensive disclosure of its full scope or all of its features.

According to several embodiments of the present disclosure, a gravity conveyor assembly includes a body including a female slot created in a first surface of the body. A track member includes a frictional engagement portion received in the female slot of the body and frictionally engaged within the female slot. A track extending portion freely extends above the first surface of the body. The track extending portion is oriented at an angle with respect to an axis oriented transverse to a ground surface such that the track extending portion has a continuous slope with respect to the ground surface.

According to additional embodiments, a gravity conveyor assembly includes first and second track assemblies positioned parallel to each other. Each of the track assemblies includes a body, including a female slot created in a first surface of the body. A track member includes a frictional engagement portion received in the female slot of the body and frictionally engaged within the female slot. A track extending portion freely extends above the first surface of the body. The track extending portion is oriented at an angle with respect to an axis oriented transverse to a ground surface such that the track extending portion has a continuous slope with respect to the ground surface. A cassette is supported on the first and second track members and is adapted for gravity induced rolling motion by the continuous slope.

According to further embodiments, a cassette supported on the first and second track members is adapted for gravity induced rolling motion by the continuous slope. The cassette includes opposed pairs of wheels each having a concave outer surface adapted to contact and roll on the track extending portion of each of the first and second track assemblies.

According to still further embodiments, a bracket body is fastenably connected to the body. A retention arm integrally extends from the bracket body and is axially aligned with the track extension portion. An end face of the retention arm is positioned at an overlap dimension with respect to the concave perimeter surface to preclude the wheels from being removed from the first and second track members.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side elevational view of the equipment and flow paths of a gravity conveyor system of the present disclosure;

FIG. 2 is a side elevational view of area 2 of FIG. 1 with the equipment shown reversed by 180 degrees;

FIG. 3 is the side elevational view of FIG. 2 modified to show a continuing flow path of components;

FIG. 4 is the side elevational view of FIG. 2 further modified to show the continuing flow path of components;

FIG. 5 is a top plan view of a conveyor and elevator configuration of the present disclosure;

FIG. 6 is an end elevational view of the conveyor and elevator configuration of FIG. 5;

FIG. 7 is an end elevational view of a conveyor assembly according to several embodiments of the present disclosure;

FIG. 8 is an end elevational perspective view of another embodiment of a conveyor assembly of the present disclosure;

FIG. 9 is an end elevational view of the conveyor assembly of FIG. 8;

FIG. 10 is top plan perspective view of a cassette of the present disclosure;

FIG. 11 is front elevational view of an inclined conveyor track assembly of the present disclosure;

FIG. 12 is a partial cross sectional end elevational view of another embodiment of an extruded body adapted for conveyor system support;

FIG. 13 is a top left perspective view of another embodiment of a cassette; and

FIG. 14 is a front elevational view of the cassette of FIG. 13.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

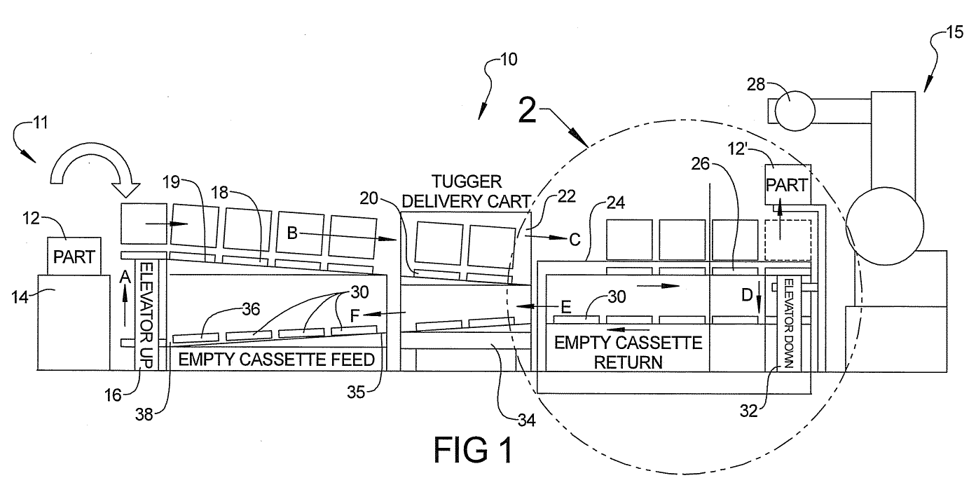

Referring to FIG. 1, a gravity conveyor system 10 of the present disclosure provides for the transportation from an assembly station 11 of a part 12 that was assembled using an assembly device 14 to an installation station 15. From the assembly device 14 the part 12 is lifted using an elevator 16 in a lift direction “A” to be supported by an individual wheeled pallet or cassette 18 which is induced to move by gravity using a gravity conveyor 19. Multiple cassettes 18 each having an individual part 12 can be moved on the gravity conveyor 19 in a first gravity induced transfer path “B” to be received by a cassette transfer device 20 of a delivery device 22. Delivery device 22 can be for example a tugger delivery cart which is capable of self propulsion from the assembly station 11 to an installation station 24. At installation station 24 each of the cassettes 18 and parts 12 are gravity off-loaded for installation of each of the parts 12 using the installation station 15. Multiple ones of the cassettes 18 and parts 12 move in the second gravity induced transferred path “C” to a position where they are stopped temporarily using a cassette braking system 26. Once stopped by the braking system 26, individual ones of the parts such as part 12′ are accessed using an installation device 28 for subsequent assembly, for example into an automobile vehicle (not shown) which is being assembled. It should be understood that installation device 28 can be used to move parts 12′ for any type of installation such as electrical components for use on electrical component circuit boards, components for assembly line installations, and the like.

Once the part 12′ has been removed from its cassette 18, the cassette re-designated as an empty cassette 30 is downwardly displaced using a second elevator 32 in an elevator transfer direction “D” so that the empty cassettes 30 can be returned to be refilled. From the installation station 24 the empty cassettes 18 gravity feed in a third gravity induced transfer path “E” to a lower receiving section of a delivery device passive transfer portion 34 of delivery device 22. From delivery device 22 the empty cassettes 30 are transferred in a fourth gravity induced transfer path “F” onto a gravity conveyor 35 which is positioned below gravity conveyor 19. Each of the empty cassettes 30 move in the fourth gravity induced transfer path “F” until they individually reach a next loading cassette position 36 defining a pick-up location 38 where the empty cassette 30 is transferred in the lift direction “A” by elevator 16 to receive a new part 12. It is also envisioned in additional embodiments of the present disclosure that the delivery device 22 can be eliminated such that the cassettes 18 having parts 12 can directly transfer from gravity conveyor 19 to installation station 24.

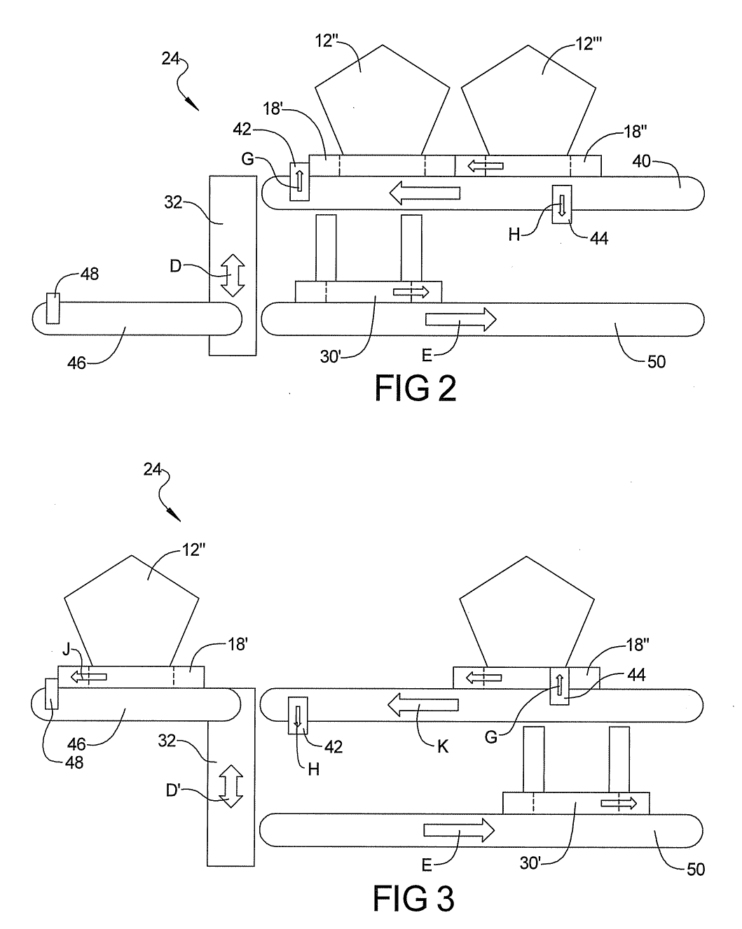

Referring to FIG. 2, a portion of installation station 24 is shown in greater detail and includes a gravity conveyor assembly 40 having a first retention member 42 which is displaceable in a retention member extension direction “G” to temporarily restrain a first cassette 18′ and a second cassette 18″ in a back-to-back configuration. At this stage first cassette 18′ carries a part 12″, and second cassette 18″ carries a part 12′″. First retention member 42 is positioned as shown to prevent further gravity induced motion of the first and second cassettes 18′, 18″ while a second retention member 44 is positioned in a retention member retraction direction “H”. Retention of first and second cassettes 18′, 18″ permits offloading of a first empty cassette 30′ from the lowered elevator support member 46 that extends from second elevator 32. Elevator support member 46 is movable upwardly or downwardly in an elevator transfer direction “D” and further includes a third retention member 48 to aid in retaining any of the empty cassettes 30 received from conveyor assembly 40. The first empty cassette 30′ rolls off of elevator support member 46 onto a second conveyor assembly 50 such that the first empty cassette 30′ is induced to roll by gravity in the third gravity induced transfer path “E”.

Referring to FIG. 3, elevator support member 46 has been displaced in an upward direction “D′” such that elevator support member 46 aligns with conveyor assembly 40. At this time, second retention member 44 is extended in the retention member extension direction “G” to physically prevent movement of second cassette 18″. Once second retention member 44 is extended, first retention member 42 is retracted in the retention member retraction direction “H” to allow gravity displacement of first cassette 18′ together with part 12″ in a cassette loading direction “J” onto elevator support member 46. During this period, first empty cassette 30′ continues its gravity induced motion in the third gravity induced transfer path “E” along second conveyor assembly 50. This motion of first empty cassette 30′ provides an open space to subsequently receive first cassette 18′ after part 12″ has been removed.

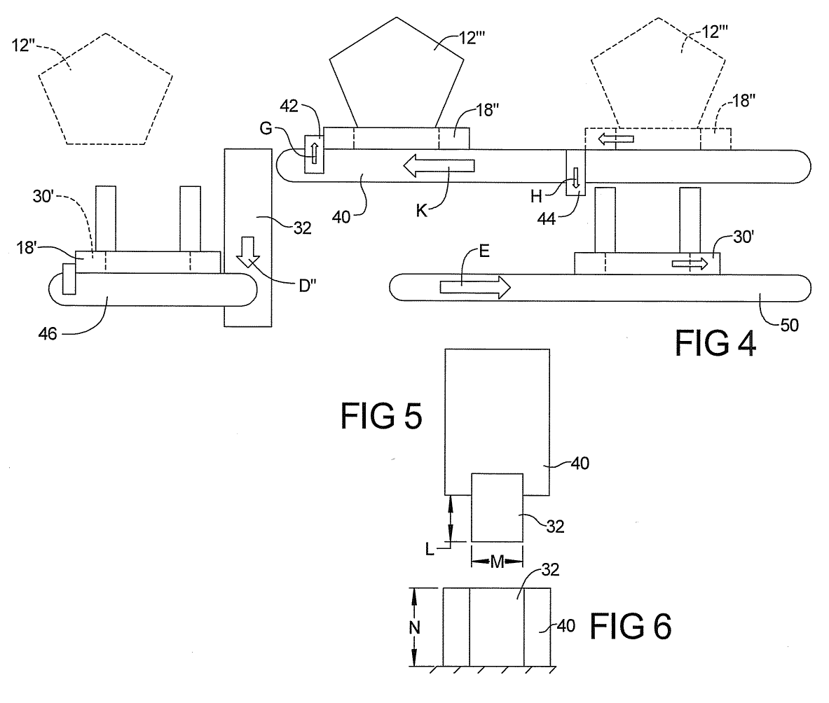

Referring to FIG. 4, after part 12″ is removed from first cassette 18′, first cassette 18′ is moved in a downward component of elevator transfer direction “D″” on elevator support member 46 until elevator support member 46 once again aligns with second conveyor assembly 50. First cassette 18′ which is now re-designated as a second empty cassette 30′ rolls onto second conveyor assembly 50 to follow first empty cassette 30′. During the downward displacement of elevator support member 46, second retention member 44 is retracted in the retention member retraction direction “H” to allow second cassette 18″ having part 12′″ to roll by gravity inducement along conveyor assembly 40 from the position shown in phantom to the restrained position created by contact with first retention member 42. First retention member 42 is displaced in the retention member extension direction “G” at the same time as second retention member 44 is displaced to receive the second cassette 18″ which rolls in a cassette transfer direction “K”.

Referring to FIG. 5, an exemplary orientation of second elevator 32 with respect to conveyor assembly 40 positions the second elevator 32 at a stand-off dimension “L” from conveyor assembly 40. Elevator stand-off dimension “L”, in addition to an elevator width “M” are predetermined to suit the dimensions of the cassettes 18 to be received on second elevator 32. This permits the free transfer of cassettes 18 using second elevator 32 providing clearance for the cassettes 18 to the conveyor assembly 40. It should be understood that similar configurations are provided for each of the conveyor assemblies of the present disclosure with respect to their corresponding elevators.

Referring to FIG. 6, it is desirable that second elevator 32 and conveyor assembly 40 each have a common elevator height “N”. Common elevator height “N” promotes gravity induced transfer of the cassettes from the conveyor assembly onto the second elevator 32.

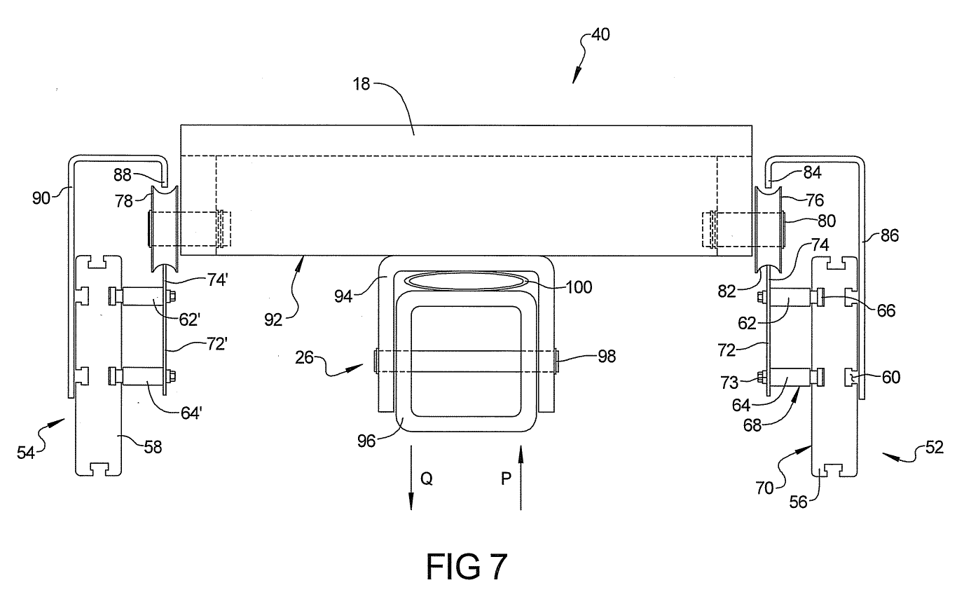

Referring to FIG. 7, according to several embodiments, conveyor assembly 40 can include parallel first and second track assemblies 52, 54. First and second track assemblies 52, 54 individually include a first extruded body 56 and a second extruded body 58 respectively. First and second extruded bodies 56, 58 can be made from multiple different materials including a metal such as aluminum or a plastic material. First and second extruded bodies, 56, 58 can also be replaced using bodies formed from other processes such as by drawing, casting, injection molding, or forging without varying from the scope of the present disclosure. Because each of the first and seconded extruded bodies 56, 58 and the first and second track assemblies 52, 54 are substantially mirror image configurations of each other only first track assembly 52 will be further described herein. A plurality of elongated slots 60 are created in first extruded body 56 which are adapted to receive first and second fasteners 62, 64 such that a fastener head 66 of each of the first and second fasteners 62, 64 is slidably received in one of the elongated slots 60. A fastener body 68 extends outwardly from a body face 70 of first extruded body 56. The fastener body 68 of both first and second fasteners 62, 64 have substantially identical lengths such that a rail plate 72 made from a material such as blue steal is positioned in parallel with body face 70. A nut 73 is connected to each of the first and second fasteners 62, 64 to retain rail plate 72. A portion of rail plate 72 designated as a rail portion 74 freely extends above first fastener 62.

Each cassette 18 includes a pair of first side wheels 76, 76′ (only first side wheel 76 is shown in this view) and an opposite pair of second side wheels 78, 78′ (second side wheel 78′ is not shown in this view). Each of the first and second side wheels 76, 76′, 78, 78′ are rotatably supported on a wheel mount pin 80 which is either fastenably connected or integrally extends from cassette 18. The rail plates 72, 72′ are positioned parallel to each other for their entire length such that a concave surface 82 of each of the first and second side wheels 76, 76′, 78, 78′ is supported by one of the rail portions 74, 74′. The concave surface 82 is adapted to allow limited side-to-side motion of cassettes 18 as well as side-to-side deflection of the first and second side wheels 76, 76′, 78, 78′ during motion of cassettes 18 as they roll on the rail plates 72, 72′. A further purpose of concave surfaces 82 is to provide a self-centering feature for the cassettes as they roll on the rail portions 74, 74′.

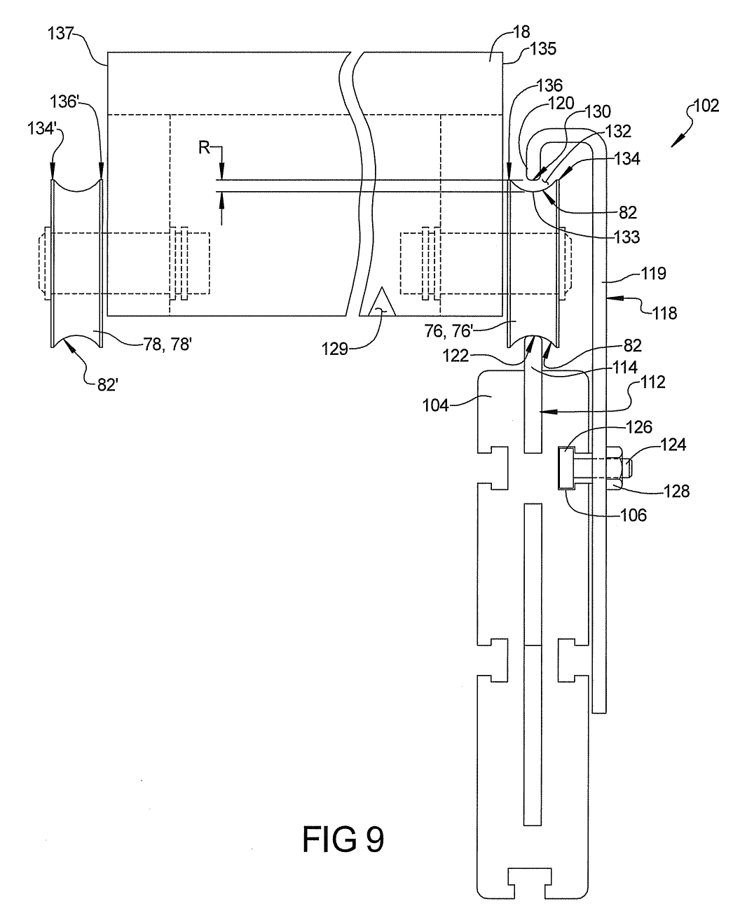

To prevent vertical displacement or removal of cassettes 18 during any of the transfer phases, a retention arm 84 of a bracket 86 fastenably connected to first extruded body 56 and a second retention arm 88 of a second bracket 90 which is fastenably connected to second extruded body 58 are positioned as shown in alignment with the concave surface of each of the first and second side wheels. The positioning and spacing of retention arms 84, 88 will be described in better detail in reference to the arrangement shown in FIG. 9.

According to several embodiments cassette braking system 26 is adapted to frictionally engage a lower surface 92 of the cassettes 18. Cassette braking system 26 can include a moving member 94 which is connected to a support member 96 using a fastener 98. Moving member 94 is movable with respect to support member 96 in either of an engagement direction “P” or a disengagement direction “Q”. An expandable member 100 can be positioned between support member 96 and moving member 94. According to several embodiments expandable member 100 is a flexible member such as an air bag which expands and contracts depending upon a pressure of a fluid introduced into the expandable member 100. As increased braking is required, a fluid such as air, water, or hydraulic fluid can be pumped into expandable member 100 to force moving member 94 upwards in the engagement direction “P” to frictionally engage the lower surface 92 of a cassette 18. To release and permit subsequent rolling motion of the cassette 18, the fluid within expandable member 100 is released, deflating expandable member 100 and allowing moving member 94 to displace in the disengagement direction “Q” until moving member 94 is no longer in frictional contact with the lower surface 92.

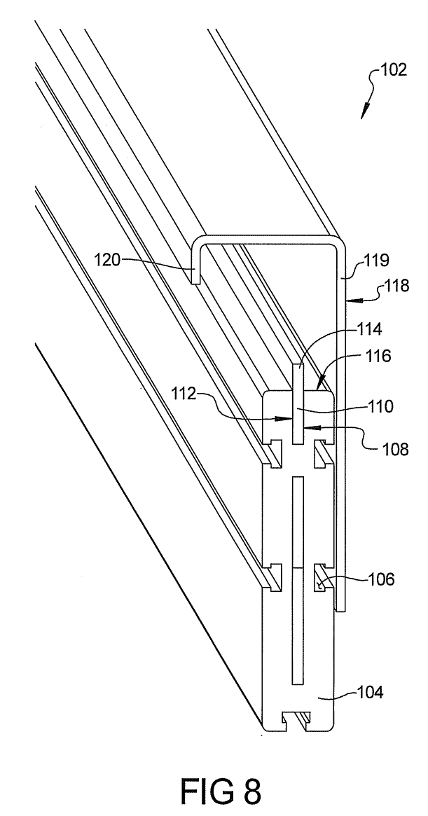

Referring to FIG. 8, according to additional embodiments of the present disclosure a third track assembly 102 provides a third extruded body 104 which includes a plurality of elongated slots 106 similar to elongated slots 60 of first and second track assemblies 52, 54. Third extruded body 104 is modified to include a female slot 108 which frictionally receives and engages a frictional engagement portion 110 of a track member 112. A track extending portion 114 of track member 112 extends above an upper surface 116 of third extruded body 104. The track extending portion 114 provides support for the various wheels of the cassettes. The embodiment shown in FIG. 8 reduces the overall quantity of parts by eliminating first and second fasteners 62, 64 compared to the embodiments shown in FIG. 7 and provides for a constant height of the track extending portion 114 by controlling the depth of the female slot 108 as well as the width of the track member 112. Material of track member 112 can be a metal including a blue steal material, or a plastic material. A modified bracket 118 having a bracket body 119 can be fastenably connected to third extruded body 104 at individual ones of the plurality of elongated slots 106 similar to the embodiments shown in FIG. 7. Modified bracket 118 includes a retention arm 120 which can be aligned on an opposite side of third extruded body 104 with respect to bracket body 119, or can be axially aligned with a central axis of track extending portion 114 as shown in reference to FIG. 9. The third extruded body 104, as well as the other extruded bodies of the present disclosure, can be bent to a minimum radius to provide for track curvature. The extruded bodies can be bent before or after insertion of the track member.

Referring to FIG. 9, third track assembly 102 is shown as it interfaces with first side wheel 76 and second side wheel 78 of cassette 18. Track extending portion 114 can have a rounded surface 122 which corresponds to a geometry of the concave surface 82 of the first and second side wheels 76, 78. Use of rounded surface 122 reduces frictional wear on concave surface 82 compared to having sharp corners at the end of track extending portion 114. An exemplary fastener 124 is shown which can be used to fasten bracket body 119 of modified bracket 118 to third extruded body 104. Fastener 124 includes a fastener head 126 slidably received in one of the elongated slots 106. A nut 128 can be applied to a threaded end of fastener 124 to engage bracket body 119 against an outer face of third extruded body 104. A slot such as a triangular-shaped or other geometrically shaped alignment slot 129 can be provided on a forward directed face of the cassettes 18. Alignment slot 129 can be used in combination with a similarly shaped male member provided between pairs of the extruded bodies to axially align each cassette 18 for more accurate location of the cassette 18 during loading or offloading operations.

According to several embodiments retention arm 120 of modified bracket 118 is aligned with track extending portion 114 and includes an arm and a face 130 which is positioned within a cavity 132 defined by concave surface 82 between a base point 133 and an outer perimeter edge 134 and an inner perimeter edge 136 of first side wheel 76. An overlap dimension “R” of arm end face 130 within the cavity 132 is controlled to prevent the first and second side wheels 76, 78 from disengaging from track extending portion 114. Overlap dimension “R” can be controlled by adjusting a vertical position of modified bracket 118 using fasteners 124.

According to several embodiments, each cassette 18 includes at least first and second wheels 76, 76′, 78, 78′ also configured as pairs of wheels individually mounted to opposed sides 135, 137 of the cassette 18. Each of the wheels 76, 76′, 78, 78′ have a perimeter concave surface 82, 82′ positioned between an inner perimeter edge 136, 136′ and an outer perimeter edge 134, 134′. The perimeter concave surface 82, 82′ of each of the wheels 76, 76′, 78, 78′ is aligned for rolling contact with the track extending portion 114 of individual ones of the first and second track assemblies.

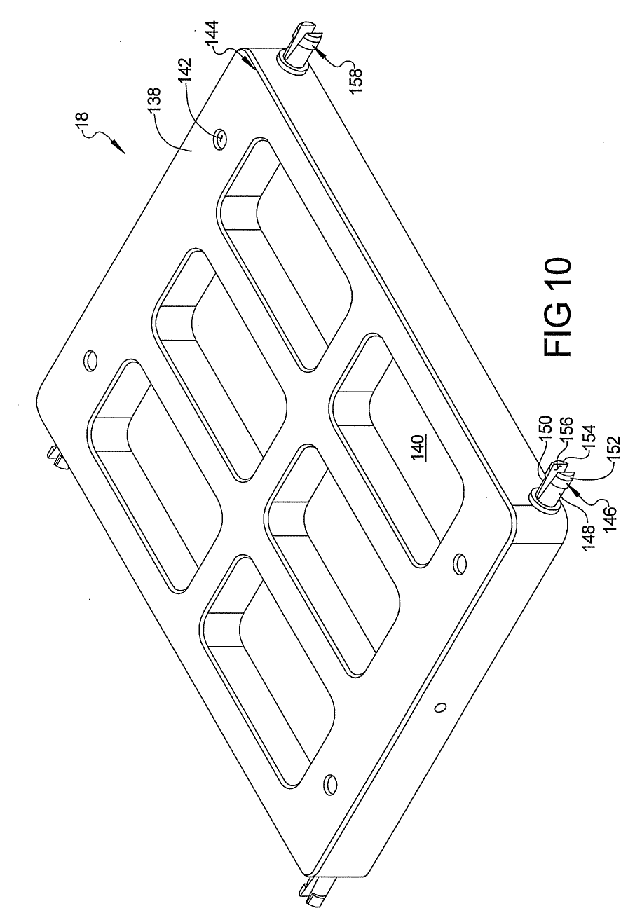

Referring to FIG. 10, an exemplary cassette 18 can be made from a molded plastic material, a cast metal material, or manufactured from a metal material including a cassette body 138. Cassette body 138 can include one or more weight reduction cavities 140 and at least one and preferably a plurality of object connection support apertures 142. Object connection support apertures 142 can be used to connect restraints to provide containment boundaries for the parts that are normally carried by cassettes 18. The attached restraints can vary in geometry depending upon the geometry of the parts 12 to be carried. Cassette body 138 can further include a plurality of wheel mount pins 146. Wheel mount pins 146 can be fastened or otherwise mechanically connected to side walls of cassette body 138, or can also be integrally connected when the cassette 18 is molded or cast such that the wheel mount pins 146 are molded or cast of the same material and at the same time that cassette body 138 is molded or cast, defining an integral, homogeneous connection between the plurality of wheel mount pins 146 and cassette body 138. Each of the wheel mount pins 146 can further include a first pin portion 148 and a second pin portion 150 which are elastically deflectable toward and away from each other to allow a wheel to be mounted on each of the wheel mount pins. The mounted wheels are retained by contact with first and second flared flanges 152, 154 individually provided with one of the first and second pin portions 148, 150. A clearance space 156 is provided in the as molded or as constructed configuration of each of the wheel mount pins 146.

Referring to FIG. 10 and again to FIGS. 7 and 9, first and second flared flanges 152, 154 are oriented opposite to each other and extend radially outward from their respective first and second pin portions 148, 150. As one of the first or second side wheels 76, 78 is slidably engaged over the wheel mount pins 146, the first and second flared flanges 152, 154 contact a sleeve of the wheel which elastically deflects the first and second pin portions 148, 150 toward each other. Once the wheel is pressed past the first and second flared flanges 152, 154 the first and second pin portions 148, 150 elastically expand outwardly such that the first and second flared flanges 152, 154 provide a positive stop to prevent removal of the individual wheel unless the first and second pin portions 148, 150 are manually deflected toward each other. A substantially flat back face 158 is provided with each of the first and second flared flanges 152, 154 which provides a positive stop to prevent the removal of the wheels under normal operating conditions.

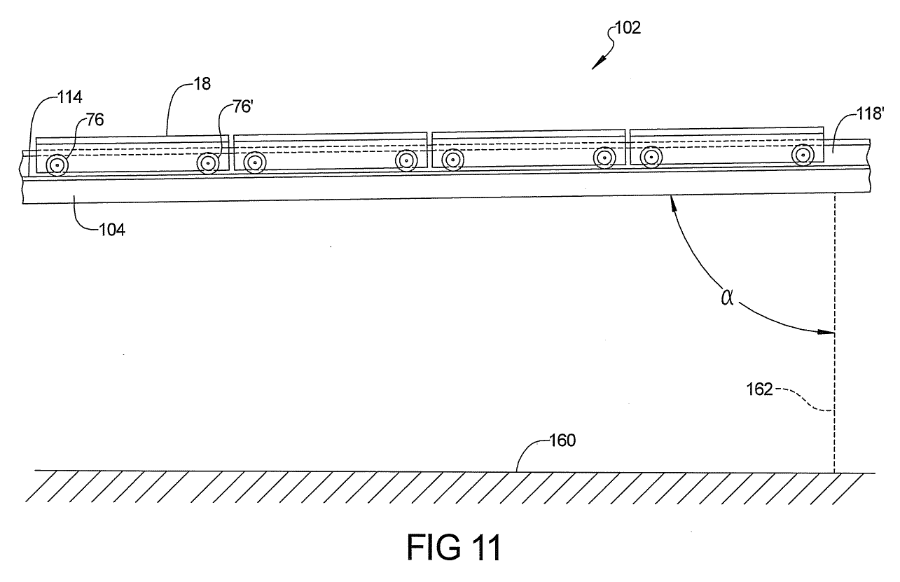

Referring to FIG. 11 and again to FIG. 9, track assemblies of the present disclosure such as third track assembly 102 shown have a continuous slope or pitch with respect to a ground surface 160 to allow for gravity transport of the plurality of cassettes 18. According to several embodiments the amount of slope is measured as an angle alpha (α) from an upper surface of the track extending portion 114 such as upper surface 116 together with track member 112 as it extends outwardly of third extruded body 104 with respect to a reference axis 162. Reference axis 162 is oriented transverse to ground surface 160. According to several embodiments angle α can range from approximately 98 degrees to approximately 99.75 degrees inclusive and preferably ranges from approximately 99 degrees to approximately 99.5 degrees inclusive. The slope of track extending portion 114 created by the use of angle α allows cassettes 18 to start rolling against a static friction of the wheels and bearings and also limits the rolling speed of the cassettes 18 to reduce a collision force between standing and moving cassettes 18.

With reference to FIGS. 8 and 11, a gravity conveyor system or assembly 102 can therefore include an extruded body 104 including a female slot 108 created in an upper or first surface 116 of the body 104. A track member 112 includes a frictional engagement portion 110 received in the female slot 108 of the body 104 and frictionally engaged within the female slot 108. A track extending portion 114 freely extends above the first surface 116 of the body 104. The track extending portion 114 is oriented at an angle α with respect to an axis 162 oriented transverse to a ground surface 160 such that the track extending portion 114 has a continuous slope (defined as 90 degrees minus angle α) with respect to the ground surface 160.

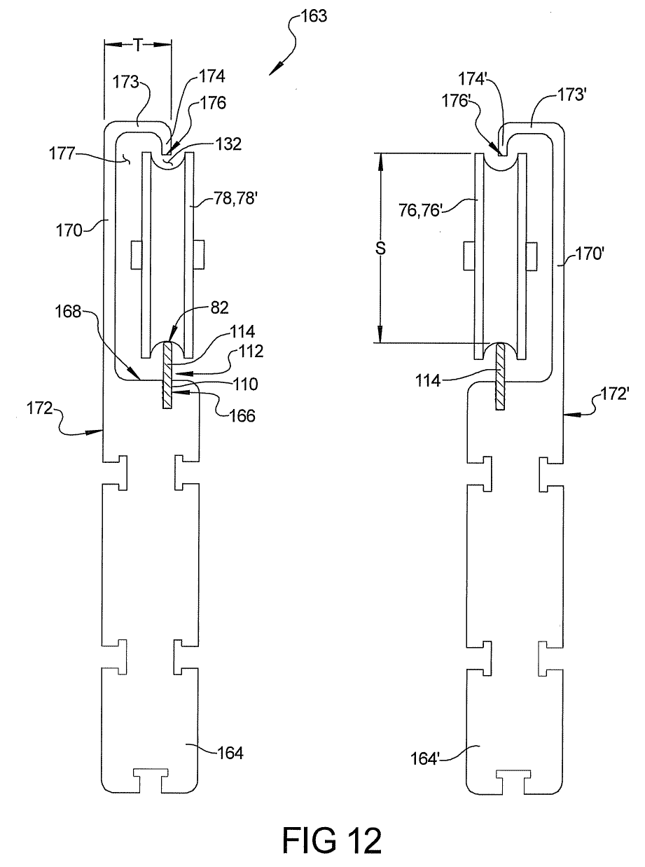

Referring to FIG. 12 and again to FIG. 8, according to additional embodiments of the present disclosure a gravity conveyor support system 163 can include a fourth extruded body 164, 164′ having a female slot 166 which frictionally receives and engages frictional engagement portion 110 of track member 112 similar to third extruded body 104. The track extending portion 114 of track member 112 extends above an upper surface 168 of fourth extruded body 164, 164′. Fourth extruded body 164, 164′ is further modified to integrally include a bracket body 170 extending from upper surface 168. Bracket body 170 can be substantially parallel to an outer surface 172 of fourth extruded body 164, 164′. An integral body end 173 can be oriented substantially perpendicular to bracket body 170 and can include an integrally connected retention arm 174 oriented substantially parallel to bracket body 170 having a face 176 positioned within the cavity 132 of second side wheels 78, 78′ (or alternately first side wheels 76, 76′). The lengths of the bracket body 170 and body end 172 are predetermined to position face 176 within cavity 132 to horizontally restrain the second side wheels 78, 78′ or alternately the first side wheels 76, 76′ and to co-axially align the retention arm 174 with the track extending portion 114 of the track member 112.

The embodiment of fourth extruded body 164, 164′ shown in FIG. 12 further reduces the overall quantity of parts compared to third extruded body 104 by integrally or homogeneously extending the bracket body 170, 170′ during extrusion of fourth extruded body 164, 164′, which eliminates fasteners and fastener receiving apertures required to attach bracket body 170, 170′ compared to third extruded body 104. The upper surface 168, bracket body 170, body end 173, and track member 112 together define a partially open wheel receiving cavity 177 adapted to receive the first or second side wheels 76, 76′, 78, 78′. A clearance “S” between face 176 and track member 112 can be predetermined to be less than an outside diameter of first and second side wheels 76, 76′, 78, 78′ to retain a portion of first and second side wheels 76, 76′, 78, 78′ within wheel receiving cavity 177. The cassette having first and second side wheels 76, 76′, 78, 78′ can therefore be restricted to end loading in a direction toward or away from the viewer with respect to FIG. 12.

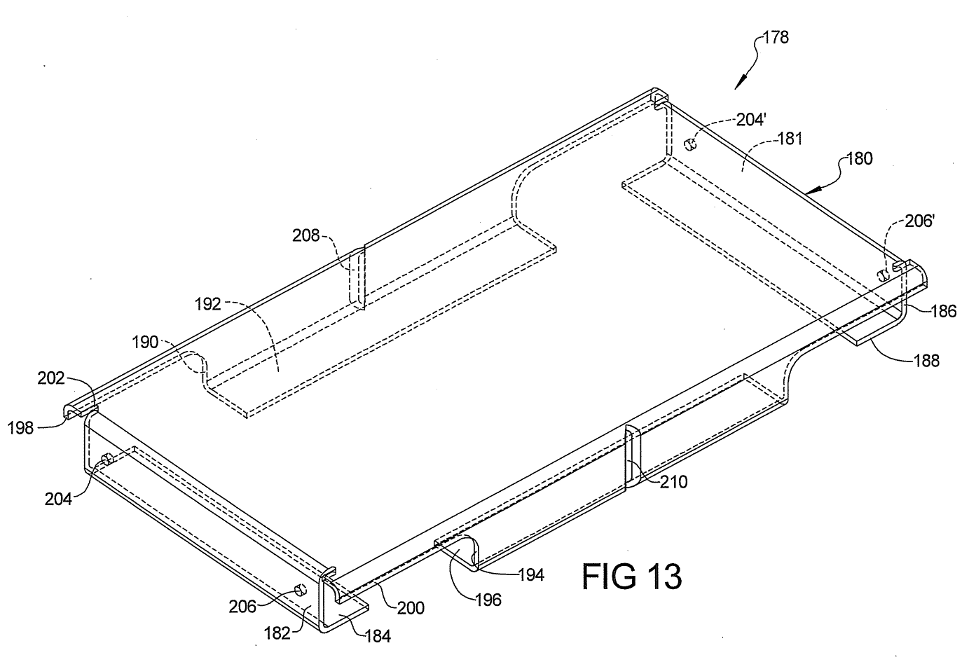

Referring to FIG. 13, a cassette 178 (shown without first or second side wheels 76, 76′, 78, 78′ for clarity) can be created from a single sheet or plate of a metal such as steel or aluminum which is bent or otherwise formed to create additional features. A cassette body 180 can include a support plate 181 having a first end wall 182 bent or formed approximately transversely thereto. A first flange 184 is oriented approximately transverse to first end wall 182 and extends inwardly. An opposed second end wall 186 is similarly bent or formed approximately transverse to support plate 181 and parallel to first end wall 182. A second flange 188 bent or formed from second end wall 186 is oriented approximately co-planar with respect to support plate 181 and extends inwardly and toward first flange 184. A third end wall 190 is bent or formed transverse to support plate 181, and is longitudinally oriented transverse to both first and second end walls 182, 186. A third flange 192 is bent or formed transverse to third end wall 190 and is directed inwardly. A fourth end wall 194 is opposed and oriented parallel with third end wall 190 similarly includes a fourth flange 196 directed inwardly and toward third flange 192. Each of the first, second, third, and fourth flanges 184, 188, 192, and 196 can be oriented co-planar to each other.

With further reference to FIG. 13 and again to FIG. 9, first and opposed second reduced bends 198, 200 reinforce the corners of cassette 178 while removing material to allow for clearance between first, second, third, and fourth flanges 184, 188, 192, 196. A clearance notch 202 is also commonly used to create each of the first, second, third, and fourth end walls 182, 186, 190, and 194. Apertures 204, 204′, 206, 206′ in first and second end walls 182, 186 are adapted for rotationally mounting the first and second side wheels 76, 76′, 78, 78′. Opposed first and second indentations 208, 210 can be formed for example by punching or swaging material of third and fourth end walls 190, 194. First and second indentations 208, 210 stiffen the third and fourth end walls 190, 194 and can further function similar to geometrically shaped alignment slot 129 described in reference to FIG. 9.

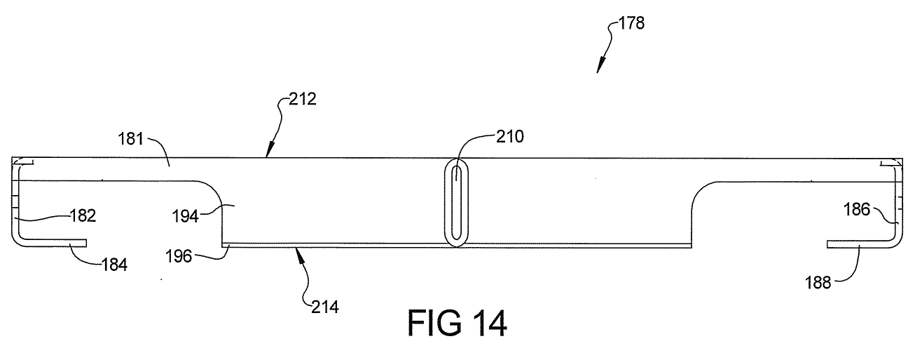

Referring to FIG. 14 and again to FIG. 7, support plate 181 defines a substantially planar surface 212 to support products carried by cassette 178. Each of the first flange 184, second flange 188, and third and fourth flanges 192, 196 (third flange 192 is not clearly visible in this view) are oriented co-planar to each other and together define a lower planar surface 214, which is parallel to planar surface 212. The portion of lower planar surface 214 defined by third and fourth flanges 192, 196 can be used as a frictional braking surface for braking cassette 178, similar to lower surface 92 described in reference to braking system 26. According to other embodiments, first and second flanges 184, 188 are not required to be co-planar with third and fourth flanges 192, 196.

Gravity conveyor systems of the present disclosure offer several advantages. By positioning a metal or plastic band of material within a receiving slot of an extruded member the rail or band is continuously supported for its entire length, eliminating high and low points that can cause cassette speed discontinuities providing a smooth operation for the cassettes. By using wheels of a cassette having a concave shape the cassette is retained on the track. By further providing a bracket which includes a retention arm partially extendable into the space provided by the concave surface of the wheels which is oppositely oriented with respect to the track extending portion, the retention arm provides a wheel retention capability to prevent the cassettes from coming off of the track until a final destination has been reached. The use of substantially identical extruded bodies of the present disclosure also allows mirror image configurations of the track supporting members which further reduces the overall quantity of components required for a track assembly of the present disclosure.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A gravity conveyor assembly, comprising:
a body including a female slot created in a first surface of the body; and
a track member including:
a frictional engagement portion received in the female slot of the body and frictionally engaged within the female slot; and
a track extending portion freely extending above the first surface of the body, the track extending portion oriented at an angle with respect to an axis oriented transverse to a ground surface such that the track extending portion has a continuous slope with respect to the ground surface.

2. The gravity conveyor assembly of claim 1, further comprising a bracket including:
a bracket body having an aperture adapted to receive a fastener extending through the aperture and connected to an elongated aperture of the body to retain the bracket with respect to the body; and
a retention arm axially aligned with the track extension portion.

3. The gravity conveyor assembly of claim 2, wherein an end face of the retention arm is positioned at an adjustable spacing from the track extension portion using the fastener.

4. The gravity conveyor assembly of claim 1, wherein the body is an aluminum extrusion having the elongated aperture extending throughout a length of the body.

5. The gravity conveyor assembly of claim 4, wherein a height of the track extending portion measured with respect to the first surface remains constant throughout a length of the body.

6. The gravity conveyor assembly of claim 1, further comprising:
a second track member configured as a mirror image and positioned in parallel to the first track member having the track extending portion of each of the first and second track members upwardly facing; and
a cassette supported on the first and second track members and adapted for gravity induced rolling motion along the continuous slope, the cassette including an alignment slot adapted to axially align the cassette during use.

7. The gravity conveyor assembly of claim 6, wherein the cassette includes:
at least first and second wheels, individually mounted to opposed sides of the cassette; and
each of the wheels having a concave perimeter surface positioned between an inner perimeter edge and an outer perimeter edge, the concave perimeter surface of each wheel aligned for rolling contact with one of the track extending portions of the first and second track members.

8. The gravity conveyor assembly of claim 7, further comprising a bracket connected to each of the first and second track members, including:
a bracket body fastenably connected to the body; and
a retention arm integrally extending from the bracket body and axially aligned with the track extension portion;
wherein an end face of the retention arm is positioned at an overlap dimension with respect to the concave perimeter surface to preclude the at least two wheels from being removed from the first and second track members.

9. The gravity conveyor assembly of claim 1, further including:
a bracket body integrally joined to and extending away from a first surface of the body and oriented parallel to a second surface of the body; and
a retention arm defining a free end of the bracket body, the retention arm directed toward the first surface.

10. The gravity conveyor assembly of claim 9, further including a body end integrally connecting the bracket body to the retention arm and spacing the retention arm at a predetermined distance from the bracket body such that the retention arm is co-axially aligned with the track extending portion.

11. The gravity conveyor assembly of claim 10, wherein a wheel receiving cavity is defined by the track extending portion, the bracket body, the body end, and the retention arm, the wheel receiving cavity adapted to receive a portion of a wheel having a circumferential concave perimeter surface positioned between an inner perimeter edge and an outer perimeter edge defining a wheel perimeter cavity, the concave perimeter surface of the wheel aligned for rolling contact with the track extending portion, the wheel being retained in the cavity having the retention arm partially received in the wheel perimeter cavity.

12. The gravity conveyor assembly of claim 1, wherein the track member comprises a metal strip having a constant thickness and a constant width throughout a length of the track member.

13. The gravity conveyor assembly of claim 1, wherein the at least one elongated aperture is created on a second surface of the body oriented transverse to the first surface.

14. A gravity conveyor assembly, comprising:
first and second track assemblies positioned parallel to each other, each including:
a body, including a female slot created in a first surface of the body; and
a track member, including:
a frictional engagement portion received in the female slot of the body and frictionally engaged within the female slot; and
a track extending portion freely extending above the first surface of the body, the track extending portion oriented at an angle with respect to an axis oriented transverse to a ground surface such that the track extending portion has a continuous slope with respect to the ground surface; and
a cassette supported on the first and second track members and adapted for gravity induced rolling motion by the continuous slope.

15. The gravity conveyor assembly of claim 14, further comprising:
a plurality of elongated apertures created in the body; and
a bracket connected to each of the first and second track members having a bracket body fastenably connected to the body using a plurality of fasteners individually received in the plurality of elongated apertures of the body.

16. The gravity conveyor assembly of claim 15, wherein the bracket further includes a retention arm integrally extending from the bracket body and axially aligned with the track extending portion.

17. The gravity conveyor assembly of claim 14, wherein the cassette includes:
at least first and second wheels individually mounted to opposed sides of the cassette; and
each of the wheels having a concave perimeter surface positioned between an inner perimeter edge and an outer perimeter edge, the concave perimeter surface of each of the wheels aligned for rolling contact with the track extending portion of individual ones of the first and second track assemblies.

18. The gravity conveyor assembly of claim 14, further including:
first and second pairs of wheels individually mounted to opposed sides of the cassette, each of the wheels having a concave perimeter surface adapted to rollingly contact the track extending portion of the track members; and
a bracket connected to the body of each of the first and second track assemblies having a retention arm axially aligned with the track extending portion wherein an end face of the retention arm is positioned at an overlap dimension with respect to the concave perimeter surface of each of the wheels to preclude removal of the wheels and the cassette from the first and second track members.

19. A gravity conveyor system, comprising:
first and second track assemblies positioned parallel to each other, each including:
a body, including a female slot created in a first surface of the body; and
a track member, including:
a frictional engagement portion received in the female slot of the body and frictionally engaged within the female slot; and
a track extending portion freely extending above the first surface of the body, the track extending portion oriented at an angle with respect to an axis oriented transverse to a ground surface such that the track extending portion has a continuous slope with respect to the ground surface; and
a cassette supported on the first and second track members and adapted for gravity induced rolling motion by the continuous slope, the cassette including opposed pairs of wheels each having a concave outer surface adapted to contact and roll on the track extending portion of each of the first and second track assemblies.

20. The gravity conveyor system of claim 19, further including:
third and fourth track assemblies each configured similar to the first and second track assemblies and positioned parallel to each other;
an elevator connected at an end of the first and second track assemblies adapted to raise the cassette to an elevated height of the third and fourth track assemblies to enable the cassette to roll by gravity on the third and fourth track assemblies to deliver a part carried by the cassette to an installation station.

21. The gravity conveyor system of claim 19, further including a delivery device having a cassette transfer device including fifth and sixth track assemblies each configured similar to the first and second track assemblies, the fifth and sixth track assemblies being positioned parallel to each other, the delivery device being mobile to permit delivery of the cassette to the installation station remote from the first and second track assemblies, wherein the cassette transfer device is aligned with the third and fourth track assemblies to permit the cassette to load by gravity from the fifth and sixth track assemblies onto the third and fourth track assemblies.

22. The gravity conveyor system of claim 19, further including:
a first elevator adapted to lift a part onto a cassette rollingly supported on the first and second track assemblies for gravity induced transfer to a delivery device; and
a transfer device of the delivery device permitting gravity induced transfer of the cassette and part to an installation station.

23. The gravity conveyor system of claim 22, further including:
a second elevator in the installation station adapted to lift the part from the cassette;
a gravity induced transfer path of the installation station adapted to allow the cassette as an empty cassette to return to the transfer device; and
an empty cassette gravity conveyor adapted to receive the empty cassette and transfer the empty cassette to the first elevator.

24. A gravity conveyor assembly, comprising:
first and second track assemblies positioned parallel to each other, each including:
a body including a female slot created in a first surface of the body and a plurality of elongated apertures;
a track member, including:
a frictional engagement portion received in the female slot of the body and frictionally engaged within the female slot; and
a track extending portion freely extending above the first surface of the body, the track extending portion oriented at an angle with respect to an axis oriented transverse to a ground surface such that the track extending portion has a continuous slope with respect to the ground surface; and
a bracket having a bracket body fastenably connected to the body using a plurality of fasteners individually received in the plurality of elongated apertures, the bracket including a retention arm integrally extending from the bracket body and axially aligned with the track extending portion.

25. The gravity conveyor assembly of claim 24, further including:
a cassette including wheels each having a concave outer surface adapted to contact and roll on the track extending portion of each of the first and second track assemblies; and
multiple pins created as integral extensions of a body of the cassette, each adapted to receive one of the wheels.

26. The gravity conveyor assembly of claim 25, wherein each of the pins includes:
first and second pin portions having a clearance space separating the first and second pin portions; and
first and second flared flanges each integrally connected to one of the first and second pin portions and oppositely directed from each other;
the first and second pin portions being elastically deflectable towards each other when one of the wheels is engaged with the first and second pin portions until the wheel extends past the first and second flared flanges, the first and second pin portions thereafter elastically deflecting away from each other such that the first and second flared flanges contact the wheel to prevent removal of the wheel.

27. The gravity conveyor assembly of claim 26, further including a back face created on each of the first and second flared flanges to assist in retaining the wheel.

28. The gravity conveyor assembly of claim 24, further including a cassette supported on the track extending portion of the first and second track members and adapted for gravity induced rolling motion by the continuous slope, the cassette including wheels each having a concave outer surface adapted to contact and roll on the track extending portion of each of the first and second track assemblies.

29. A gravity conveyor assembly, comprising:
an extrusion body including a plurality of elongated slots created in a first surface of the extrusion body;
a flat plate track member fastened to the extrusion body using first and second fasteners engaged within individual ones of the plurality of elongated slots, the track member having a track extending portion freely extending above the first fastener, the track extending portion oriented at an angle with respect to an axis oriented transverse to a ground surface such that the track extending portion has a continuous slope with respect to the ground surface; and
a bracket having a bracket body fastenably connected to the body, the bracket including a retention arm integrally extending from the bracket body and axially aligned with the track extending portion.

30. A gravity conveyor support system, comprising:
a body including:
a bracket body integrally joined to and extending away from a first surface of the body and oriented parallel to a second surface of the body;
a retention arm defining a free end of the bracket body, the retention arm directed toward the first surface; and
a female slot created in and oriented transverse to the first surface of the body; and
a track member including:
a frictional engagement portion received and frictionally engaged in the female slot of the body; and
a track extending portion freely extending above the first surface of the body, the track extending portion and the first surface oriented at an angle with respect to an axis oriented transverse to a ground surface such that the first surface and the track extending portion are oriented at a continuous slope with respect to the ground surface.

31. The gravity conveyor support system of claim 30, further including a body end integrally connecting the bracket body to the retention arm spacing the retention arm at a predetermined distance from the bracket body such that the retention arm is co-axially aligned with the track extending portion.

32. The gravity conveyor support system of claim 31, wherein the upper surface, the bracket body, the body end, and the track member together define a partially open cavity.

33. The gravity conveyor support system of claim 30, wherein the angle ranges from approximately 98 degrees to approximately 99.75 degrees inclusive.

34. The gravity conveyor support system of claim 30, wherein the track extending portion includes a rounded surface oriented parallel to the first surface such that the rounded surface and the first surface are together oriented at the angle, the angle ranging from approximately 99 degrees to approximately 99.5 degrees inclusive.
